(19) United States
(12) Patent Application Publication
(10) Pub. No.: US 2007/0074008 A1
(43) Pub. Date: Mar. 29, 2007

(54) Mixed mode floating-point pipeline with extended functions

(76) Inventor: David D. Donofrio, Benicia, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/237,006

(22) Filed: Sep. 28, 2005

(51) Int. Cl. G06F 9/44

(52) U.S. Cl. 712/222

(57) ABSTRACT

An embodiment of the present invention is a technique to perform mixed mode floating-point (FP) operations and extended FP functions. A sequencer controls issuing an instruction operating on an input vector. A mixed mode FP pipeline computes an extended FP function or an integer operation of the input vector using an extended internal format and a series of multiply-add operations. The mixed mode FP pipeline generates a pipeline state to the sequencer and an FP result.

### BACKGROUND

1. Field of the Invention

Embodiments of the invention relate to the field of microprocessors, and more specifically, to floating-point units.

2. Description of Related Art

Use of floating-point (FP) operations is becoming increasingly prevalent in many areas of computations such as three-dimensional (3-D) computer graphics, image processing, digital signal processing, weather predictions, space explorations, seismic processing, and numerical analysis. Specially designed floating-point units have been developed to enhance FP computational power in a computer system. Many of FP applications involve computations of extended functions. Examples of extended functions are trigonometric functions, exponential and logarithmic functions, square root, reciprocal square root, inverse, divide, and power functions, etc.

Existing techniques to compute FP extended functions have a number of drawbacks. These techniques range from interpolations of values obtained from a table to iterative algorithms such as the Coordinate Rotation Digital Computer (CORDIC) technique. These techniques may require specialized hardware with dedicated circuits. They are typically expensive and not flexible to accommodate a wide range of extended functions.

### BRIEF DESCRIPTION OF THE DRAWINGS

Embodiments of invention may best be understood by referring to the following description and accompanying drawings that are used to illustrate embodiments of the invention. In the drawings:

FIG. 1A is a diagram illustrating a processing system in which one embodiment of the invention can be practiced.

FIG. 1B is a diagram illustrating a graphics system in which one embodiment of the invention can be practiced.

FIG. 2 is a diagram illustrating a FPU according to one embodiment of the invention.

FIG. 3 is a diagram illustrating a mixed mode FP pipeline according to one embodiment of the invention.

FIG. 4 is a diagram illustrating an internal format according to one embodiment of the invention.

FIG. 5 is a flowchart illustrating a process to perform mixed mode computations according to one embodiment of the invention.

FIG. 6 is a flowchart illustrating a process to control issuing instructions according to one embodiment of the invention.

FIG. 7 is a flowchart illustrating a process to compute an extended FP function or long integer operation according to one embodiment of the invention.

FIG. 8 is a flowchart illustrating a process to assemble the FP result according to one embodiment of the invention.

### DESCRIPTION

An embodiment of the present invention is a technique to perform mixed mode floating-point (FP) operations and extended FP functions. A sequencer controls issuing an instruction operating on an input vector. A mixed mode FP pipeline computes an extended FP function or an integer operation of the input vector using an extended internal format and a series of multiply-add operations. The mixed mode FP pipeline generates a pipeline state to the sequencer and an FP result.

In the following description, numerous specific details are set forth. However, it is understood that embodiments of the invention may be practiced without these specific details. In other instances, well-known circuits, structures, and techniques have not been shown to avoid obscuring the understanding of this description.

One embodiment of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, a method of manufacturing or fabrication, etc.

One embodiment of the invention is a technique to perform mixed mode FP operations efficiently. The mixed mode allows for both FP and integer operations. This may be achieved by using an extended internal format that is compatible with FP and integer representations. The technique also allows for efficient computations of extended functions such as trigonometric, exponential, logarithmic, square root, and power functions. The computation of the extended function is based on polynomial approximation using the basic multiply-add (MAD) instruction which computes an expression of the form Y=A×B+C.

A typical polynomial approximation may be divided into three phases: a range reduction phase, an approximation phase, and a reconstruction phase. The range reduction phase converts an argument to a value that is confined in a reduced range. The approximation phase performs the polynomial approximation of the function of the range reduced argument. The reconstruction phase composes the final result with pre-defined constant or constants to restore the original range. Typically, the range reduction and reconstruction phases are straightforward and may be implemented efficiently. They may include simple masking, comparison, or low-order polynomial evaluation. The approximation phase is the most time-consuming phase because the order of the polynomial may be quite high (e.g., greater than 20).

In the approximation phase, Homer's rule may be employed to factor out the multiply-and-add expressions, reducing the number of multiplications. For example, a fourth order polynomial y=ax⁴+bx³+cx²+dx+e may be evaluated as:
y=(((ax+b)x+c)x+d)x+e (1)

The above expression essentially requires only 4 MAD instructions to evaluate:
A=ax+b (2a)
B=Ax+c (2b)
C=Bx+d (2c)
D=Cx+e=y (2d)

In general, for an n-^{th} order polynomial
f(x)=a₀xⁿ+a₁xⁿ⁻¹+ . . . +aₖx^{n-k}+aₖ₊₁ (3)

The evaluation of the polynomial may be efficiently carried out by performing n MAD operations, with each operation containing new coefficients aᵢ, where i=0, . . . , k.

Another technique to compute some extended functions is the Newton-Raphson method. A common equation used to approximate an inverse is:
xᵢ=xᵢ₋₁(2−axᵢ₋₁) (4)

This recursive equation may be evaluated in two MAD operations. Similar equations may be used to approximate reciprocal square root, division using reciprocation, etc. as well known in the art.

One embodiment of the invention provides a pipeline having a series of MAD units. Multiple MAD units may be cascaded in series or a single MAD unit may be used. Operations issued to these cascaded MAD units, or the single MAD unit, may be iterated as many times as necessary to achieve the desired result. The iteration may be done by providing a feedback path to re-circulate the output of the unit back to its input.

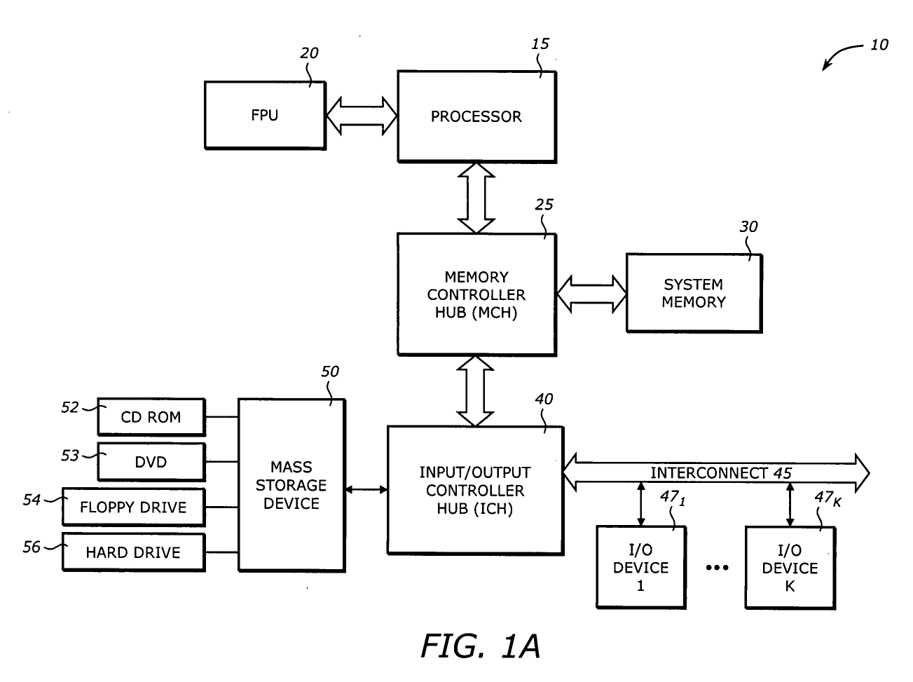

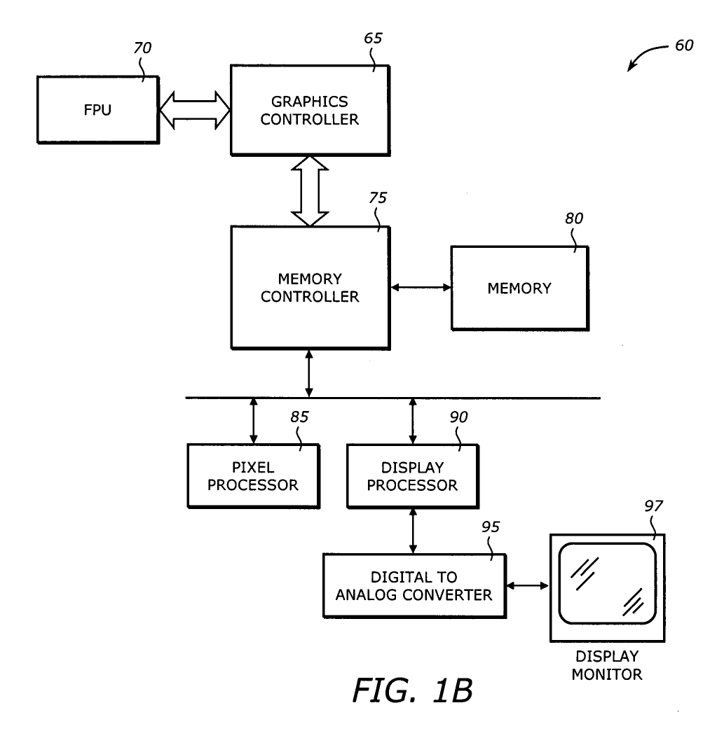

FIG. 1A is a diagram illustrating a processing system 10 in which one embodiment of the invention can be practiced. The system 10 includes a processor unit 15, a floating-point unit (FPU) 20, a memory controller hub (MCH) 25, a main memory 30, an input/output controller hub (IOH) 40, an interconnect 45, a mass storage device 50, and input/output (I/O devices 47ᵢ to 47_{K}.

The processor unit 15 represents a central processing unit of any type of architecture, such as processors using hyper threading, security, network, digital media technologies, single-core processors, multi-core processors, embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture.

The FPU 20 is a co-processor that performs floating-point operations for vector processing. It may have direct interface to the processing unit 15 and may share system resources with the processing unit 15 such as memory space. The processing unit 15 and the FPU 20 may exchange instructions and data including vector data and FP instructions. The FPU 20 may also be viewed as an input/output (I/O) processor that occupies an address space of the processing unit 15. It may also be interfaced to the MCH 25 instead of directly to the processor unit 15. It uses a highly scalable architecture with a mixed mode FP pipeline for scalar and vector processing.

The MCH 25 provides control and configuration of memory and input/output devices such as the main memory 30 and the ICH 40. The MCH 25 may be integrated into a chipset that integrates multiple functionalities such as graphics, media, isolated execution mode, host-to-peripheral bus interface, memory control, power management, etc. The MCH 25 or the memory controller functionality in the MCH 25 may be integrated in the processor unit 15. In some embodiments, the memory controller, either internal or external to the processor unit 15, may work for all cores or processors in the processor unit 15. In other embodiments, it may include different portions that may work separately for different cores or processors in the processor unit 15.

The main memory 30 stores system code and data. The main memory 30 is typically implemented with dynamic random access memory (DRAM), static random access memory (SRAM), or any other types of memories including those that do not need to be refreshed. The main memory 30 may be accessible to the processor unit 15 or both of the processor unit 15 and the FPU 20.

The ICH 40 has a number of functionalities that are designed to support I/O functions. The ICH 40 may also be integrated into a chipset together or separate from the MCH 20 to perform I/O functions. The ICH 40 may include a number of interface and I/O functions such as peripheral component interconnect (PCI) bus interface, processor interface, interrupt controller, direct memory access (DMA) controller, power management logic, timer, system management bus (SMBus), universal serial bus (USB) interface, mass storage interface, low pin count (LPC) interface, etc.

The interconnect 45 provides interface to peripheral devices. The interconnect 45 may be point-to-point or connected to multiple devices. For clarity, not all the interconnects are shown. It is contemplated that the interconnect 45 may include any interconnect or bus such as Peripheral Component Interconnect (PCI), PCI Express, Universal Serial Bus (USB), and Direct Media Interface (DMI), etc.

The mass storage device 50 stores archive information such as code, programs, files, data, and applications. The mass storage device 50 may include compact disk (CD) read-only memory (ROM) 52, digital video/versatile disc (DVD) 53, floppy drive 54, and hard drive 56, and any other magnetic or optic storage devices. The mass storage device 50 provides a mechanism to read machine-accessible media. The I/O devices 47_{I} to 47_{K} may include any I/O devices to perform I/O functions. Examples of I/O devices 47_{I} to 47_{K} include controller for input devices (e.g., keyboard, mouse, trackball, pointing device), media card (e.g., audio, video, graphic), network card, and any other peripheral controllers.

FIG. 1B is a diagram illustrating a graphics system 60 in which one embodiment of the invention can be practiced. The graphics system 60 includes a graphics controller 65, a floating-point unit (FPU) 70, a memory controller 75, a memory 80, a pixel processor 85, a display processor 90, a digital-to-analog converter (DAC) 95, and a display monitor.

The graphics controller 65 is any processor that has graphic capabilities to perform graphics operations such as fast line drawing, two-dimensional (2-D) and three-dimensional (3-D) graphic rendering functions, shading, anti-aliasing, polygon rendering, transparency effect, color space conversion, alpha-blending, chroma-keying, etc. The FPU 70 is essentially similar to the FPU 20 shown in FIG. 1A. It performs floating-point operations on the graphic data. It may receive FP instructions and FP vector inputs from, and return the FP results to the graphics controller 65. The memory controller 75 performs memory control functions similar to the MCH 25 in FIG. 1A. The memory 80 includes SRAM or DRAM memory devices to store instructions and graphic data processed by the graphic controller 60 and the FPU 70.

The pixel processor 85 is a specialized graphic engine that can perform specific and complex graphic functions such as geometry calculations, affine conversions, model view projections, 3-D clipping, etc. The pixel processor 85 is also interfaced to the memory controller 70 to access the memory 80 and/or the graphic controller 65. The display processor 90 processes displaying the graphic data and performs display-related functions such as palette table look-up, synchronization, backlight controller, video processing, etc. The DAC 95 converts digital display digital data to analog video signal to the display monitor 97. The display monitor 97 is any display monitor that displays the graphic information on the screen for viewing. The display monitor may be a Cathode Ray Tube (CRT) monitor, a television (TV) set, a Liquid Crystal Display (LCD), a Flat Panel, or a Digital CRT.

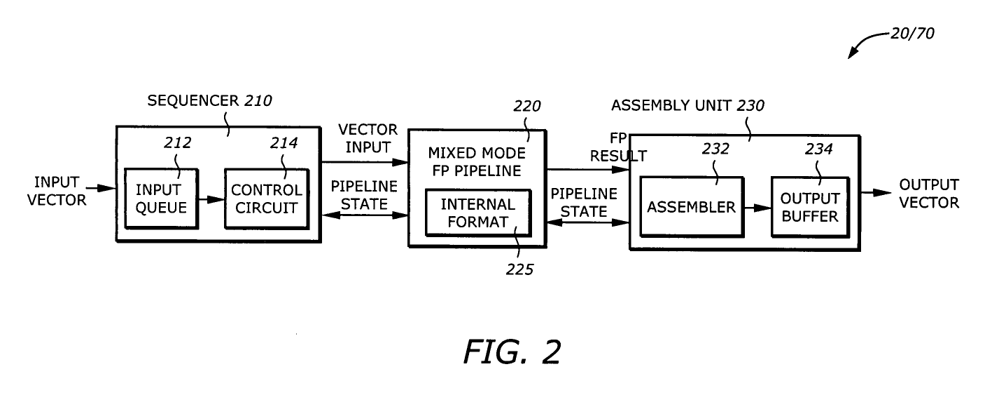

FIG. 2 is a diagram illustrating the FPU 20/70 shown in FIGS. 1A and 1B according to one embodiment of the invention. The FPU 20/70 includes a sequencer 210, a mixed mode FP pipeline 220, and an assembly unit 230.

The sequencer 210 controls issuing an instruction operating on an input vector. The input vector may be provided by an external unit or processor such as the processor unit 15 (FIG. 1A) or the graphics controller 65 (FIG. 1B). The sequencer 210 includes an input queue 212 and a control circuit 214. The input queue 212 stores a number of input vectors and instructions. Its depth may be any suitable depth according to the throughput and processing requirements. It may be implemented by a first in first out (FIFO) or any other storage architecture. Each input vector may include N scalar components, where N is any positive integer. Each scalar component may be a FP number or an integer. The format of the scalar component is compatible with the internal format of the mixed mode FP pipeline 220. The control circuit 214 dispatches the input vector obtained from the input queue 212 and issues the instruction associated with the input vector according to a pipeline state of the mixed mode FP pipeline 220.

The mixed mode FP pipeline 220 computes an extended FP function or an integer operation of the input vector using an extended internal format 225 and a series of multiply-add operations. It generates a pipeline state to the sequencer 220 and an FP result to the assembly unit 230. The extended FP function may be any one of transcendental functions such as trigonometric functions (e.g., tangent, sine, cosine, inverse tangent, inverse sine, inverse cosine), exponential and logarithmic functions, division, square root, etc. The integer operation may be any integer operation such as integer addition, subtraction, multiplication, division, etc.

The assembly unit 230 assembles the FP result into an output vector. It includes an assembler 232 and an output buffer 234. The assembler 232 obtains the FP result which may correspond to the computational result of a scalar component of the input vector and writes to the output buffer at an appropriate scalar position. When all the scalar results are written to the output buffer, the complete output vector is read out by an external unit or processor such as the processor unit 15 or the graphics controller 65.

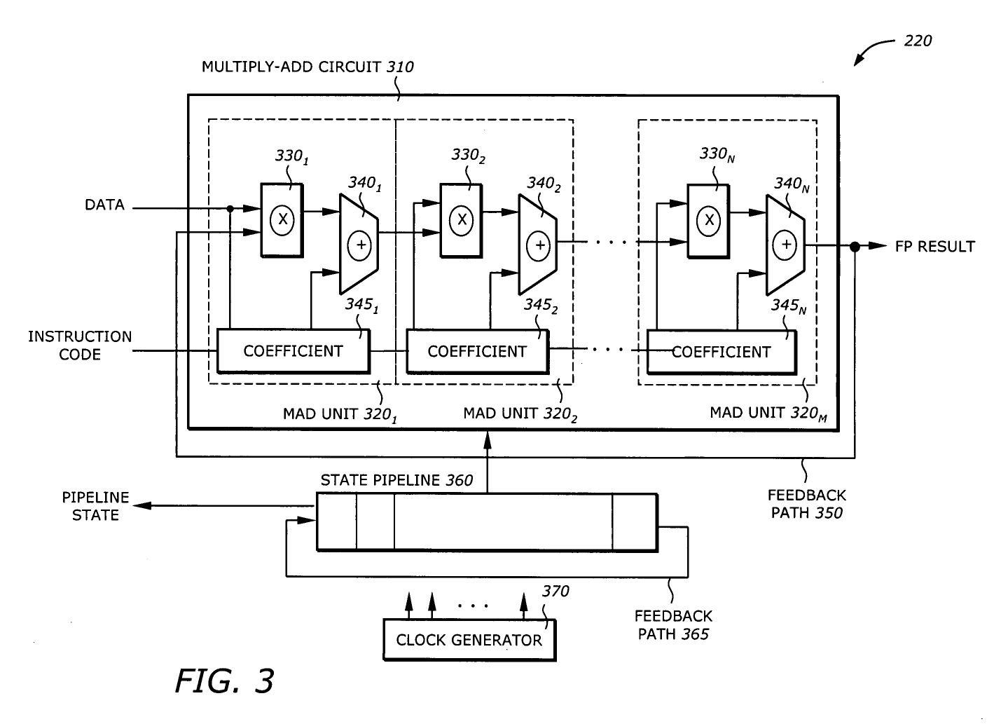

FIG. 3 is a diagram illustrating the mixed mode. FP pipeline 220 shown in FIG. 2 according to one embodiment of the invention. The mixed mode FP pipeline 220 includes a multiply-add circuit 310, a state pipeline 360 and a clock generator 370. It is noted that the multiply-add circuit 310 is used to illustrate one embodiment of the invention to compute extended functions using polynomial approximation. The specific implementation may be modified to accommodate other techniques, such as computations using the Newton-Raphson technique.

The multiply-add circuit 310 performs a series of multiply-and-add operations. The multiply-and-add operation is the basic operation in computing extended functions using the polynomial approximation technique. In one embodiment, the multiply-and-add operation is a fused multiply-and-add operation because there is no intermediate rounding between the multiply and the addition. Typically, this operation is performed in a single instruction or in one single clock. The fused multiply-and-add operation allows for a high precision. The multiply-add circuit 310 includes N MAD units 320_{I} to 320_{N} where N may be any positive integer including 1. The N MAD units 320_{I} to 320_{N} are typically identical and cascaded in series to perform multiple MAD operations. The output of the last MAD unit is re-circulated back to the input of the first MAD unit through a feedback path 350.

The MAD unit 320ᵢ, i=1, . . . , N, includes a multiplier 330ᵢ, an adder 340ᵢ, and a coefficient storage 345ᵢ. The multiplier 330₁ has one input representing the argument x in the polynomial f(x) as shown in equation (3). The other input of the first multiplier 330₁ is connected to the feedback path 350. All other multipliers have one input connected to the output of the adder of the previous stage and the second input connected to the coefficient storage. The adder 340ᵢ adds the output of the multiplier 330ᵢ with the output of the coefficient storage 345ᵢ. The coefficient storage 345ᵢ stores the coefficients aᵢ (i=0, . . . , k+1), the original argument x in equation (3) as well as any necessary constants to complete the operation, such as 1.0, 0.0, etc.

The state pipeline 360 controls FP modes for the FP computations in the multiply-and-add circuit 310. The FP modes may include rounding modes, precision modes, exception handling, operation being performed, current status, etc. The state pipeline 360 also generates the pipeline state to indicate if an instruction is being re-circulated in the feedback path 350. The pipeline state is used by the sequencer 210 and the assembly unit 230 to control issuing instructions. The state pipeline 360 has a feedback path 365 to correspond to the feedback path 350. Its latency is matched with the latency of the multiply-add circuit 310.

The clock generator 370 generates various clock signals to synchronize the operations. For example, the MAD units 320_{I} to 320_{N} may be clocked to control the propagation of the data. The clock generator 370 also provides clock signals to the sequencer 210 and the assembly unit 230.

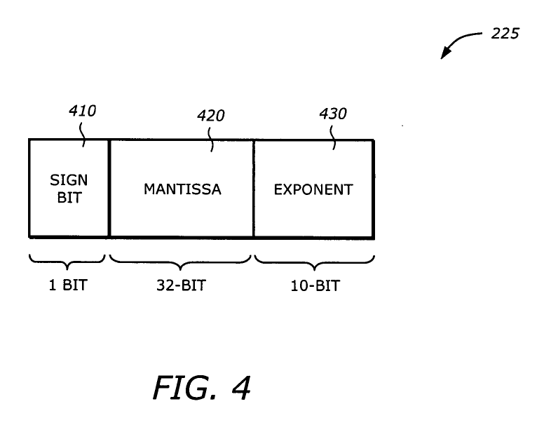

FIG. 4 is a diagram illustrating the extended internal format 225 shown in FIG. 2 according to one embodiment of the invention. The extended internal format 225 has an extended representation compared to a standard floating-point representation such as the Institute of Electrical and Electronics Engineers (IEEE) single precision format.

The extended internal format 225 includes a sign field 410, a mantissa field 420, and an exponent field 430. The sign field 410 indicates the sign of the number. It is typically a one-bit field. For example, it is 1 for a negative number and 0 for a positive number. The mantissa field 420 may have 32 bits. The exponent field 430 may have 10 bits. This representation allows long integer numbers to be fully represented in the mantissa field 420 while the exponent field 430 is set to a fixed value of 31 which is equal to the mantissa width minus one.

The extended internal format 225 as represented above provides a number of advantages compared to a standard single precision FP format. Some of the advantages are the following:
The exponent field width of 10-bit (2 bits wider than the standard single precision FP format) allows for representing values outside the normal standard range. This is useful to accommodate overflows underflows of the intermediate values during the computation although the final result may be within the range.
The mantissa field width of 32-bit combined with the additional precision gained from the fused MAD units allows for functions to be represented with greater precision than the standard FP format. This is useful for evaluation of functions such as the logarithmic and exponential functions using 2^{y log 2x}=x^{y}.
32-bit integers may be represented using the same hardware instead of a separate dedicated integer hardware or circuit. This allows for mixed mode operations, resulting in significant hardware saving.
The additional precision gained from a 32-bit mantissa and a fused MAD allows for division by reciprocation through an additional Newton-Raphson iteration. The Newton-Raphson technique converges quadratically, meaning that the number of bits of precision doubles with each iteration. Therefore, after computing a 24-bit FP approximation, this value may be re-circulated through the pipeline and a 48-bit approximation may be obtained which is then rounded back to 32-bit.

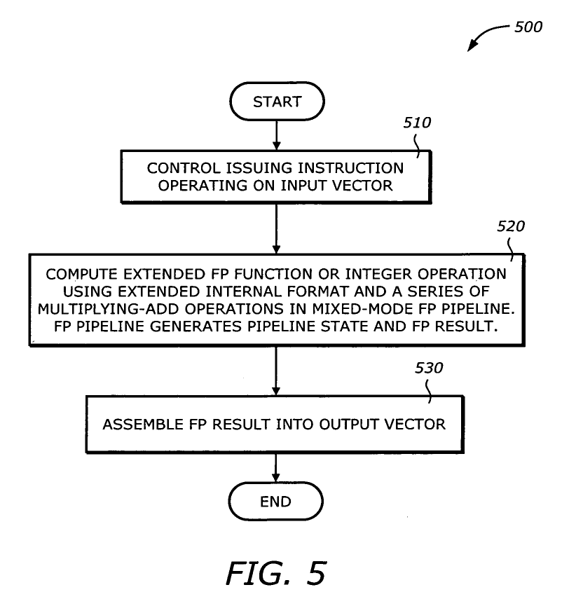

FIG. 5 is a flowchart illustrating a process 500 to perform mixed mode computations according to one embodiment of the invention.

Upon START, the process 500 controls issuing the instruction that operates on an input vector (Block 510). Then, the process 500 computes an extended FP function or an integer operation using an extended internal format and a series of multiply-add operations in a mixed mode FP pipeline (Block 520). The mixed mode FP pipeline generates a pipeline state and a FP result. Then, the process 500 assembles the FP result into an output vector (Block 530) and is then terminated.

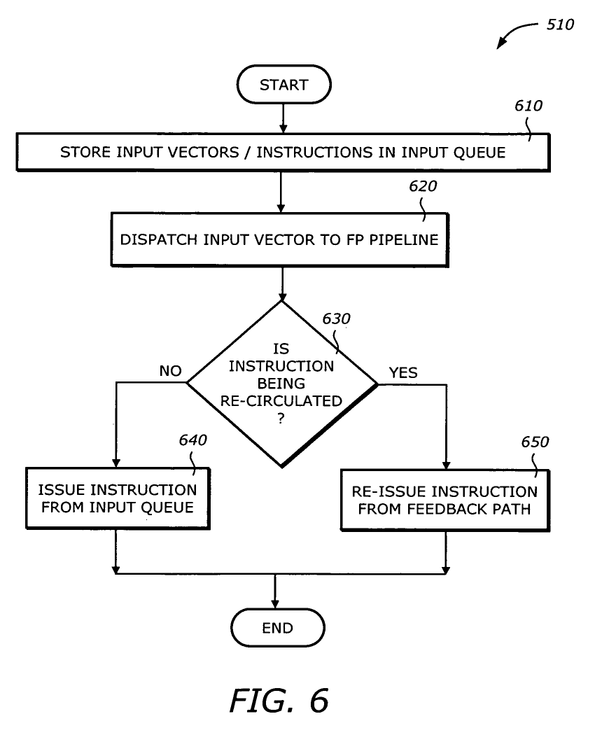

FIG. 6 is a flowchart illustrating the process 510 to control issuing instructions according to one embodiment of the invention.

Upon START, the process 510 stores the input vectors and instructions in an input queue (Block 610). Next, the process 510 dispatches an input vector to the FP pipeline (Block 620). Then, the process 510 determines if the instruction is being re-circulated in the feedback path (Block 630). This may be done by checking the pipeline state. If not, the process 510 issues a next instruction from the input queue (Block 640) and is then terminated. Otherwise, the process 510 re-issues the same instruction as the instruction from the feedback path (Block 650) and is then terminated.

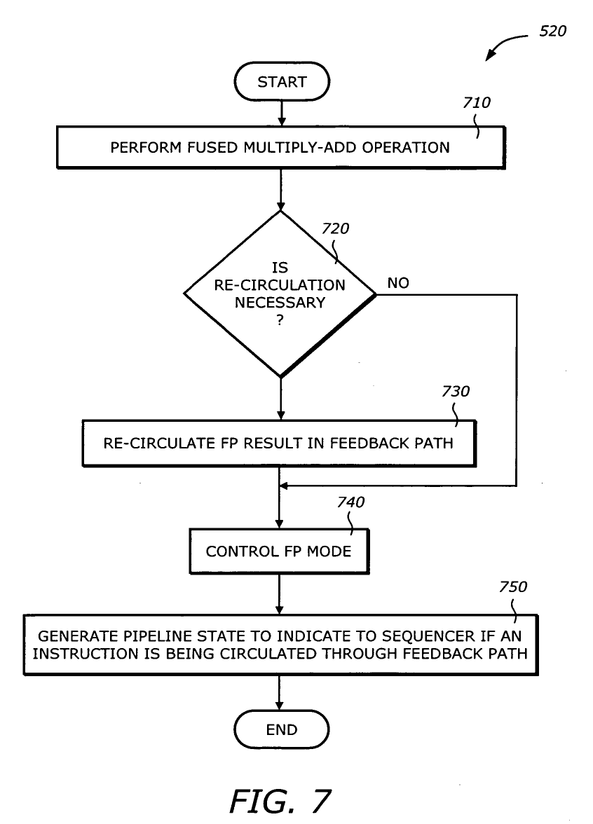

FIG. 7 is a flowchart illustrating the process 520 to compute an extended FP function or an integer operation according to one embodiment of the invention.

Upon START, the process 520 performs a fused multiply-add operation (Block 710). Next, the process 520 determines if a re-circulation is necessary (Block 720). If not, the process 520 proceeds to Block 740. Otherwise, the process 520 re-circulates the FP result in the feedback path (Block 730). Then, the process 520 controls the FP modes (Block 740). This may include controlling the rounding mode, the precision mode, exception handling, etc. Next, the process 520 generates the pipeline state to indicate if an instruction is being re-circulated in the feedback path (Block 750) and is then terminated.

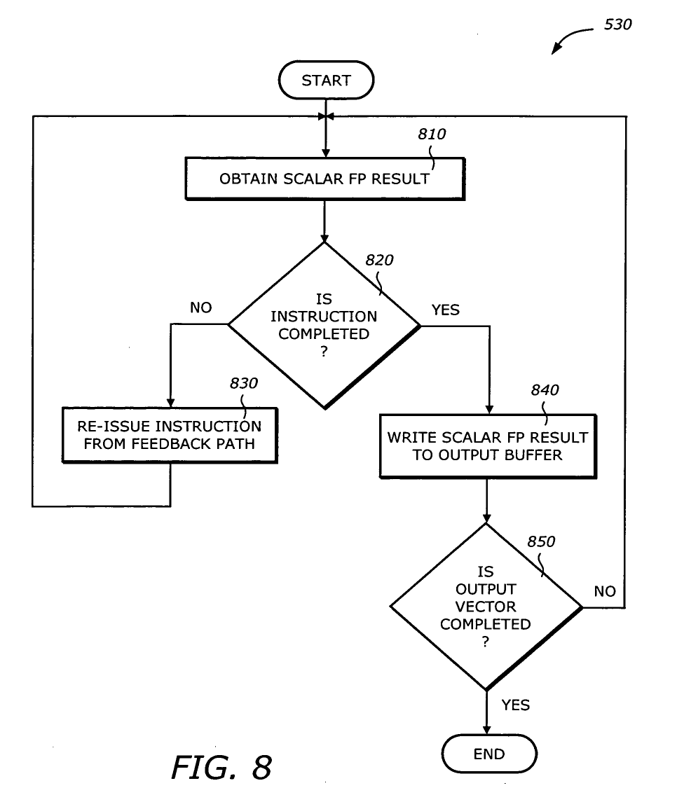

FIG. 8 is a flowchart illustrating the process 530 to assemble the FP result according to one embodiment of the invention.

Upon START, the process 530 obtains the FP result at the output of the FP pipeline (Block 810). Next, the process 530 determines if the instruction is completed (Block 820). This may be accomplished by checking the pipeline state. If there is no re-circulation in the feedback path, then the instruction is completed. Otherwise, the instruction has not yet completed.

If the instruction is not completed, the process 530 re-issues the instruction from the feedback path (Block 830) and then returns to Block 810 to continue obtaining the next FP result. Otherwise, the process 530 writes the FP result to the output buffer at the appropriate position corresponding to the scalar position in the vector (Block 840). Then, the process 530 determines if the output vector is completed.(Block 850). If not, the process 530 returns back to Block 810 to continue obtaining the next FP result. Otherwise, the process 530 is terminated.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

What is claimed is:

1. An apparatus comprising:
a sequencer to control issuing an instruction operating on an input vector; and
a mixed mode floating-point (FP) pipeline coupled to the sequencer to compute an extended FP function or an integer operation of the input vector using an extended internal format and a series of multiply-add operations, the mixed mode FP pipeline generating a pipeline state to the sequencer and an FP result.

2. The apparatus of claim 1 further comprising:
an assembly unit coupled to the mixed mode FP pipeline to assemble the FP result into an output vector.

3. The apparatus of claim 1 wherein the sequencer comprises:
an input queue to store a plurality of input vectors and instructions; and
a control circuit coupled to the input queue to dispatch the input vector obtained from the input queue and issue the instruction according to the pipeline state of the mixed mode FP pipeline.

4. The apparatus of claim 2 wherein the mixed mode FP pipeline comprises:
a multiply-add circuit to perform a fused multiply and add operation;
a feedback path to re-circulate the FP result to input of the FP pipeline; and
a state pipeline to control FP modes and generate the pipeline state, the pipeline state indicating if an instruction is being re-circulated in the feedback path.

5. The apparatus of claim 4 wherein the control circuit issues the instruction from the input queue if the pipeline state indicates that there is no instruction being re-circulated in the feedback path.

6. The apparatus of claim 3 wherein the control circuit re-issues the instruction from the feedback path if the pipeline state indicates that the instruction is being re-circulated in the feedback path.

7. The apparatus of claim 4 wherein the assembler writes the FP result to an output buffer if the pipeline state indicates that there is no instruction being re-circulated in the feedback path.

8. The apparatus of claim 1 wherein the extended internal format has an extended representation of mantissa and exponent compared to a standard floating-point format.

9. The apparatus of claim 8 wherein the extended internal format includes a sign bit, 32-bit mantissa, and 10-bit exponent.

10. A method comprising:
controlling issuing an instruction operating on an input vector; and
computing an extended FP function or an integer operation of the input vector using a series of multiply-add operations in a mixed mode FP pipeline, the mixed mode FP pipeline generating a pipeline state and an FP result.

11. The method of claim 10 further comprising:
assembling the FP result into an output vector.

12. The method of claim 10 wherein controlling issuing the instruction comprises:
storing a plurality of input vectors and instructions in an input queue;
dispatching the input vector obtained from the input queue; and
issuing the instruction according to the pipeline state of the mixed mode FP pipeline.

13. The method of claim 11 wherein computing comprises:
performing a fused multiply and add operation;
re-circulating the FP result to input of the FP pipeline in a feedback path;
controlling FP modes; and
generating the pipeline state to indicate if an instruction is being re-circulated in the feedback path.

14. The method of claim 13 wherein issuing the instruction comprises issuing the instruction from the input queue if the pipeline state indicates that there is no instruction being re-circulated in the feedback path.

15. The method of claim 12 wherein issuing the instruction comprises re-issuing the instruction from the feedback path if the pipeline state indicates that the instruction is being re-circulated in the feedback path.

16. The method of claim 13 wherein assembling comprises writing the FP result to an output buffer if the pipeline state indicates that there is no instruction being re-circulated in the feedback path.

17. A system comprising:
a graphics controller to process graphic data;
a memory coupled to the graphics controller to store the graphic data; and
a floating-point unit (FPU) coupled to the graphics controller to perform floating-point operations on the graphic data, the FPU comprising:
a sequencer to control issuing an instruction operating on an input vector, and
a mixed mode floating-point (FP) pipeline coupled to the sequencer to compute an extended FP function or an integer operation of the input vector using an extended internal format and a series of multiply-add operations, the mixed mode FP pipeline generating a pipeline state to the sequencer and an FP result.

18. The system of claim 17 further comprising:
an assembly unit coupled to the mixed mode FP pipeline to assemble the FP result into an output vector.

19. The system of claim 17 wherein the sequencer comprises:
an input queue to store a plurality of input vectors and instructions; and
a control circuit coupled to the input queue to dispatch the input vector obtained from the input queue and issue the instruction according to the pipeline state of the mixed mode FP pipeline.

20. The system of claim 18 wherein the mixed mode FP pipeline comprises:
a multiply-add circuit to perform a fused multiply and add operation;
a feedback path to re-circulate the FP result to input of the FP pipeline; and
a state pipeline to control FP modes and generate the pipeline state, the pipeline state indicating if an instruction is being re-circulated in the feedback path.
